(19) United States
(12) Patent Application Publication
(10) Pub. No.: US 2007/0062642 A1
(43) Pub. Date: Mar. 22, 2007

(54) Method and apparatus for applying a pasty, preferably at least partially elastic substance

(75) Inventors: Guenter Reck, Wilflingen (DE); Patrick Seiler, Kernen (DE); Rainer Stettin, Kressbronn (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/602,297

(22) Filed: Nov. 21, 2006

(30) Foreign Application Priority Data
Sep. 12, 2005 (DE) 10 2005 058 852.2

(51) Int. Cl. B05D 5/00

(52) U.S. Cl. 156/325; 427/256; 118/300

(57) ABSTRACT

The invention relates to a method and an apparatus for applying a pasty, preferably at least partially elastic substance used for sealing connection of a first component to a second component. In the method, the pasty substance is pressed out of an outlet opening of an application nozzle and is applied in a positionally defined manner to a connecting face of the first component. The application nozzle and/or the first component is moved in a controlled manner by an industrial robot. A delivery pump removes the pasty substance from a reservoir. The substance is conveyed to the application nozzle via a feed line, a metering pump and a following switching device, with an application nozzle being arranged behind the switching device. The metering pump controls the pressure in the pasty substance in accordance with the actual pressure is measured in the region of the switching device.

This application claims the priority of DE 10 2005 058 852.2-45, filed Sep. 12, 2005, the disclosure of which is expressly incorporated by reference herein.

### BACKGROUND AND SUMMARY OF THE INVENTION

The invention relates to a method and an apparatus for applying a pasty, preferably at least partially elastic substance to a contact surface, and in particular a contact surface of an engine for motor vehicles.

In the previously known method and the previously known apparatus, the pasty substance is used for the later sealing connection of the first component to a contact face of a second component, which contact face is configured in the same way as the first contact face. In the method, the pasty substance, preferably a sealing adhesive and particularly preferably a silicone rubber, is pressed out of an outlet opening of an application nozzle, which outlet opening is arranged on an industrial robot, and is applied in a controlled and positionally defined manner to a connecting face of a first component in the form of a bead. Here, the delivery pressure is generated by a delivery pump, the pasty substance being conveyed from a reservoir for the pasty substance to the application nozzle by means of the delivery pump and feed lines. In order to increase the service life and to improve the application, it is known to arrange a metering valve in the vicinity of the application nozzle, by means of which metering valve the flow of the pasty substance out of the outlet opening of the application nozzle can be switched off or released. As a result of this measure, the thickness of the beads can be reduced, which is associated with, inter alia, a simpler application of the bead onto the contact face of the first component and lower loading of the pump.

Despite these measures, a further improvement is desirable, as the applied beads are still relatively wide, as a result of which the application can be difficult in some circumstances. This is true, in particular, when openings are situated in the connecting face, which openings also have to remain open in a secured manner after the second component is arranged on the first component. Furthermore, pumps which have been used previously have high wear, with which considerable retrofitting and adjustment times are associated.

The object of the invention is to develop a method and an apparatus, with which the service life of the corresponding apparatus is improved with application reliability which is as satisfactory as possible.

An improved, more uniform outflow of the pasty substance from the outlet opening of the application nozzle could be realized by the arrangement of a metering pump in a feed line between a delivery pump and a switching unit, the pressure measurement between the metering pump and the switching unit, and the maintenance of a setpoint pressure, within setpoint pressure interval limits which can be predefined, in the region between the metering pump and the switching unit, in interaction with the short line length of the feed line between the switching unit and the application nozzle, and in interaction with the application nozzle itself. As a result, it is possible in turn to apply even thinner beads of pasty substance, with which a further jump in quality is achieved.

The arrangement of the switching device in the vicinity of the application nozzle already reduces the thickness of the beads in a surprising manner. As a result of the arrangement of the metering pump and the maintenance of the pressure by means of the metering pump and the pressure sensor in front of the switching device, the output of the pasty substance is even more uniform, as a result of which the thickness of the bead can be reduced still further. This results, inter alia, in easier application of the bead to the contact face of the first component and lower loading of the delivery pump.

Here, in the vicinity of the application nozzle is to be understood as a spacing of the switching device from the application nozzle which is preferably less than a fifth, with preference less than a tenth and particularly preferably less than the last twentieth of the overall length of the feed line between the pump and the outlet opening of the application nozzle.

The service life of the apparatus is increased by the lower loading of the delivery pump. Furthermore, the spatially and positionally defined guidance is made easier, in particular, by the thinner bead, with which, inter alia, more rapid adjustment of the apparatus and therefore longer availability are associated.

The flow of the pasty substance is preferably released and interrupted by means of a metering valve which is favourably arranged on the inflow side in the region directly in front of the application nozzle. As a result, the compressible volume of pasty substance which can flow out of the outlet opening of the metering valve during an interruption is limited narrowly, in particular.

In particular, the delivery pump, the metering pump and the switching device are synchronized. As a result, the setpoint pressure can be made available or built up, if the application nozzle is released, in real time, that is to say shortly before, at or shortly after the moment of release.

If the outflow of pasty substance from the application nozzle is interrupted, the setpoint pressure is held between the metering valve and the switching device by means of the metering pump, pasty substance which is possibly missing for this purpose being made available via the delivery pump. As a result of this, the delivery pump is also, in particular, relieved and its service life is increased.

The delivery pump and the metering pump are favourably arranged outside the industrial robot, with the result that the industrial robot only has to move relatively low masses. Furthermore, the industrial robot then no longer has to be readjusted, that is to say taught, during maintenance of the delivery pump and the metering pump. The availability of the apparatus is also increased considerably as a result.

A screw-spindle pump, in which at least the walls of its pump chamber, in which the screw spindle rotates, are lined with SiC at least in regions, is expediently used as metering pump.

However, the walls of the pump chamber are preferably lined completely with SiC.

If expensive application of SiC to the walls of the pump chamber is to be dispensed with, it is possible in a simple manner to manufacture the entire housing, in which the screw spindle rotates, from SiC.

The method and the apparatus are suitable, in particular, for crankcases, to which a cylinder head and/or an oil sump is to be adhesively bonded as second component. In this case, preferably a sealing adhesive and particularly preferably a silicone rubber are used as pasty substance.

Other objects, advantages and novel features of the present invention will become apparent from the following detailed description of the invention when considered in conjunction with the accompanying drawings.

### BRIEF DESCRIPTION OF THE DRAWINGS

FIG. 1 diagrammatically shows an apparatus according to an embodiment of the present invention for applying a sealingly adhesive silicone rubber.

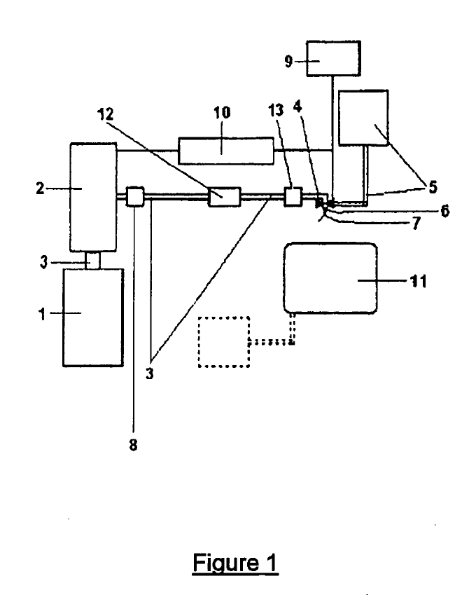

### DETAILED DESCRIPTION

With regard to the silicone rubber, the apparatus has a reservoir 1 and a delivery pump 2 which removes the silicone rubber from this reservoir 1. The pump 2 conveys the silicone rubber at a defined, in particular predefinable delivery pressure via a feed line 3 to a metering pump 12 which for its part guides it further through the feed line 3 to a metering valve 4. The metering valve 4 itself is arranged on the end region of the arm of an industrial robot 5. Furthermore, the metering valve 4 is arranged directly on an application nozzle 6 which has an outlet opening 7 for the silicone rubber. A pressure regulator 8 for monitoring the delivery pressure is arranged in the feed line 3 between the delivery pump 2 and the metering pump 12. A pressure sensor 13 is arranged in the feed line 3 between the metering pump 12 and the metering valve. A pneumatic valve 9 is connected to the metering valve 4, by way of which pneumatic valve 9 the metering valve 4 can be opened and closed in a controlled manner. This pneumatic valve 9 is connected for its part to a controller 10 which is likewise connected to the pump 2. Furthermore, the pressure sensor 13 is likewise connected to the controller 10. As a result of these connections of these components to the controller, the delivery pump 2 which is arranged outside the industrial robot 5, the metering valve 4 and the metering pump 12 can be synchronized in a desired manner, and a virtually constant pressure can be exerted on the silicone rubber in the region of the metering valve 4 and therefore the application nozzle 6.

As a replacement for or in addition to the arrangement of the application nozzle 6 on the industrial robot 5, a first component 11 can likewise be arranged on an industrial robot (illustrated with dashed lines). In the case of a stationary application nozzle 6 which is possible here, the said application nozzle 6 can then be exchanged, in particular, in a simple manner, the down times of the apparatus being reduced considerably, as a result of the changeover and simplified or omitted new adjustments. The apparatus according to the invention is suitable, in particular, for the sealing adhesive bonding of the crankcase (first component 11) to an associated cylinder head and/or an oil sump and/or a control housing cover and/or a crankshaft terminating cover and/or a cylinder head cover. To this end, the silicone rubber is pressed out of the output opening 7 of the application nozzle 6 and is applied in a positionally defined manner to the connecting face of the crankcase in the form of a bead.

For the application of the bead, the application nozzle 6 and also the metering nozzle 4 are moved in a controlled and positionally defined manner by means of the industrial robot 5. During the time, in which the connecting face is moved away with the application nozzle 4 and has the bead applied to it, the silicone rubber is conveyed by means of the delivery pump 2 and the feed line 3 out of the reservoir 1 via the metering pump 12 to the application nozzle 6 at a setpoint pressure which can be, in particular, predefined and is applied, in particular, by the metering pump.

If the application of silicone rubber is terminated or at least almost terminated, the flow of silicone rubber is interrupted by means of the metering valve 4, with the result that at most only a small amount of silicone rubber can emerge from the outlet opening 7 of the application nozzle 6.

Here, the setpoint pressure between the metering pump 12 and the metering valve 4 is maintained favourably, in particular within a pressure interval which can be predefined, by means of the controller 10 which regulates the function of the delivery pump 2, the metering valve 4 and the metering valve 12.

At the beginning of an application of silicone rubber, the metering valve 4 is opened accordingly and the setpoint pressure is regulated to its setpoint with the metering pump 12 within a pressure-related tolerance interval.

To this end, in both cases, the pressure within the feed line 3 is expediently measured in the region between the metering pump 12 and the metering valve 4.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for preparing a contact surface of a first component for sealingly connection of the first component to a contact face of a second component by application of a pasty, at least partially elastic substance to the contact surface of a first component, comprising the steps of:
removing the pasty substance from a reservoir with a delivery pump;
conveying the pasty substance to an application nozzle via a feed line;
pressing the pasty substance out of an outlet opening of the application nozzle;
applying the pressed-out pasty substance in a positionally defined manner to the contact surface of the first component in the form of a bead while positioning at least one of the application nozzle and the first component in a controlled manner with an industrial robot; and
interrupting the flow of the pasty substance with a switching device, wherein the interruption or release of the flow of the pasty substance is performed in a region of the last fifth of a length of the feed line between the delivery pump and the outlet opening of the application nozzle;
wherein
a pressure of the pasty substance is measured in the region of the switching device, and
a metering pump is actuated by a controller receiving pressure signals from the pressure sensor when the measured pressure of the pasty substance is below a predefined minimum pressure such that the pressure of the pasty substance is increased by the metering pump to a predefined setpoint pressure.

2. The method according to claim 1, wherein the flow of the pasty substance is interrupted in the region of the last tenth of the length of the feed line between the delivery pump and the outlet opening of the application nozzle.

3. The method according to claim 1, wherein the flow of the pasty substance is interrupted in the region of the last twentieth of the length of the feed line between the delivery pump and the outlet opening of the application nozzle.

4. The method according to claim 1, wherein, if the minimum pressure is undershot, the actual pressure is increased to the setpoint pressure in the region between the delivery pump (2) and the application nozzle (6).

5. The method according to claim 1, wherein the pasty substance is a sealing adhesive.

6. The method according to claim 5, wherein the sealing adhesive is a silicone rubber having an adhesive effect.

7. The method according to claim 1, wherein a crankcase is the first component and at least one of a cylinder head, an oil sump, a control housing cover, a crankshaft terminating cover and a cylinder head cover is the second component.

8. The method according to claim 1, wherein the switching device is a metering valve.

9. The method according to claim 1, wherein the setpoint pressure is generated outside the industrial robot.

10. An apparatus for preparing a contact surface of a first component for sealingly connection of the first component to a contact face of a second component by application of a pasty, at least partially elastic substance to the contact surface of a first component, comprising:
a reservoir for holding the pasty substance;
a delivery pump for removing the pasty substance from the reservoir;
a feed line for conveying the pasty substance from the delivery pump to an application nozzle;
an industrial robot for moving at least one of the application nozzle and the first component in a controlled manner while the pasty substance is pressed out of an outlet opening of the application nozzle to apply the pressed-out pasty substance in a positionally defined manner to the contact surface of the first component in the form of a bead; and
a switching device for interrupting the flow of the pasty substance provided in a region of the last fifth of a length of the feed line between the delivery pump and the outlet opening of the application nozzle;
a pressure sensor for measuring a pressure of the pasty substance in the region of the switching device; and
a metering pump, wherein the metering pump is actuated by a controller receiving pressure signals from the pressure sensor when the pressure of the pasty substance measured by the pressure sensor is below a predefined minimum pressure such that the pressure of the pasty substance is increased by the metering pump to a predefined setpoint pressure.

11. The apparatus according to claim 10, wherein the switching device is provided in the region of the last tenth of the length of the feed line between the delivery pump and the outlet opening of the application nozzle.

12. The apparatus according to claim 10, wherein the switching device is provided in the region of the last twentieth of the length of the feed line between the delivery pump and the outlet opening of the application nozzle.

13. The apparatus according to claim 10, wherein the metering pump is actuatable in a manner regulated by the pasty substance pressure.

14. The apparatus according to claim 10, wherein the pasty substance is a sealing adhesive.

15. The apparatus according to claim 14, wherein the sealing adhesive is a silicone rubber having an adhesive effect.

16. The apparatus according to claim 10, wherein the switching device is arranged on the feed line directly in front of the application nozzle.

17. The apparatus according to claim 10, wherein the first component is a crankcase and at least one of a cylinder head, an oil sump, a control housing cover, a crankshaft terminating cover and a cylinder head cover is the second component.

18. The apparatus according to claim 10, wherein the switching device is a metering valve.

19. The apparatus according to claim 10, wherein the metering pump is arranged outside the industrial robot.

20. The apparatus according to claim 10, wherein the metering pump is a screw-spindle pump.

21. The apparatus according to claim 20, wherein at least portions of walls of a pump chamber of the metering pump in which the screw spindle rotates are lined with SiC.

22. The apparatus according to claim 10, wherein the metering pump is a screw-spindle pump, and at least a housing of the metering pump is formed from SiC.
